(19) United States
(12) Patent Application Publication
(10) Pub. No.: US 2025/0188249 A1
(43) Pub. Date: Jun. 12, 2025

(54) DEGRADATION SOLUTION AND METHOD OF DECOMPOSING EPOXY RESIN

(71) Applicant: INDUSTRIAL TECHNOLOGY RESEARCH INSTITUTE, Hsinchu (TW)

(72) Inventors: Jhen-Rong CHEN, Taoyuan City (TW); Chiung-Hui HUANG, Hsinchu City (TW); Jih-Hsiang YEH, New Taipei City (TW)

(73) Assignee: INDUSTRIAL TECHNOLOGY RESEARCH INSTITUTE, Hsinchu (TW)

(21) Appl. No.: 18/391,968

(22) Filed: Dec. 21, 2023

(30) Foreign Application Priority Data
Dec. 7, 2023 (TW) 112147607

(51) Int. Cl. C08K 7/14; B29B 17/02; B29L 31/08; B29L 31/30; C08K 7/06

(52) U.S. Cl. CPC C08K 7/14; B29B 17/02; C08K 7/06; B29B 2017/0293; B29L 2031/085; B29L 2031/3005

(57) ABSTRACT

A degradation solution includes 100 parts by weight of 30 to 50 vol % of hydrogen peroxide aqueous solution, 44 to 80 parts by weight of C₂ to C₄ organic acid or anhydride thereof, 50 to 90 parts by weight of an organic acid containing a plurality of carboxylic acid groups, and 1 to 15 parts by weight of degradation auxiliary agent. The degradation solution can be used to decompose an epoxy resin.

### CROSS REFERENCE TO RELATED APPLICATIONS

The present application is based on, and claims priority from, Taiwan Application Serial Number 112147607, filed on Dec. 7, 2023, the disclosure of which is hereby incorporated by reference herein in its entirety.

### TECHNICAL FIELD

The technical field relates to a degradation solution for decomposing an epoxy resin, and in particular it relates to recycling fibers such as carbon fibers in waste materials containing the epoxy resin.

### BACKGROUND

Light-weight, high-strength thermosetting fiber reinforced composite materials account for a large portion of the fiber composite market share. Because the crosslinked structure of the thermosetting resins is stable, their waste and end-of-life products are difficult to handle. Incineration is banned due to high carbon emissions and hazardous pollution. Currently, wastes can only be reduced in volume, stacked and then disposed of by landfills, or crushed to be used as filler, resulting in a waste of resources. If the fibers can be effectively recycled and reused, it will help implementing a circular economy, eliminating waste, and reducing carbon emissions.

### SUMMARY

One embodiment of the disclosure provides a degradation solution, including: 100 parts by weight of 30 to 50 vol % of hydrogen peroxide aqueous solution; 44 to 80 parts by weight of C₂ to C₄ organic acid or anhydride thereof; 50 to 90 parts by weight of an organic acid containing a plurality of carboxylic acid groups; and 1 to 15 parts by weight of degradation auxiliary agent.

One embodiment of the disclosure provides a method of decomposing epoxy resin, including: soaking a waste material containing epoxy resin in the degradation solution at a temperature of 25° C. to 100° C. under a normal pressure for 1 to 72 hours, wherein the epoxy resin in the waste material is decomposed by the degradation solution to form a residual liquid.

A detailed description is given in the following embodiments.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details.

One embodiment of the disclosure provides a degradation solution, including: 100 parts by weight of 30 to 50 vol % of hydrogen peroxide aqueous solution and 44 to 80 parts by weight of C₂ to C₄ organic acid or anhydride thereof. The anhydride of the C₂ to C₄ organic acid in the degradation solution will form the organic acid. For example, the acetic anhydride in the degradation solution will form the acetic acid. The function of the hydrogen peroxide aqueous solution is oxidizing the carboxylic group of the organic acid. The function of the C₂ to C₄ organic acid or anhydride thereof is forming a mixing system of a small molecular organic acid and peroxyacid thereof, thereby swelling, permeating, and partially decomposing the epoxy resin. If the amount of the C₂ to C₄ organic acid or anhydride thereof is too low, the swelling effect of the epoxy resin matrix will be lowered. If the amount of the C₂ to C₄ organic acid or anhydride thereof is too high, the amount of the formed small molecular organic peroxyacid will be too low, thereby decreasing the effect of decomposing the epoxy resin.

In some embodiments, the C₂ to C₄ organic acid includes acetic acid, propionic acid, butyric acid, or a combination thereof. If the carbon number of the organic acid is too low (e.g. formic acid), it will produce a pungent odor which restrain it from being used in epoxy resin decomposition application. If the carbon number of the organic acid is too large (e.g. valeric acid), the swelling effect of the small molecules in the epoxy resin will be difficult to achieve.

The degradation solution also includes 50 to 90 parts by weight of an organic acid containing a plurality of carboxylic acid groups. The function of the organic acid containing a plurality of carboxylic acid groups is to provide a plurality of oxidizable carboxylic groups, which can be oxidized by the hydrogen peroxide to provide a plurality of functional groups that can initiate decomposition reactions with the epoxy resin. As such, the decomposition effect of the epoxy resin can be enhanced. If the amount of the organic acid containing a plurality of carboxylic acid groups is too low, the effect of accelerating the decomposition of the epoxy resin will be lowered. If the amount of the organic acid containing a plurality of carboxylic acid groups is too high, the reaction rate and the heating rate of the system will be too high to control. In some embodiments, the organic acid containing a plurality of carboxylic acid groups includes malonic acid, succinic acid, glutaric acid, maleic acid, malic acid, citric acid, or a combination thereof

The degradation solution also includes 1 to 15 parts by weight of degradation auxiliary agent. The degradation auxiliary agent is mainly a strong Lewis acid, which is beneficial to form peroxide from the C₂ to C₄ organic acid and the organic acid containing a plurality of carboxylic acid groups. If the amount of degradation auxiliary agent is too low, the formation rate of the peroxyacid will be slow. If the amount of degradation auxiliary agent is too high, it will be difficult to control the catalytic efficiency of forming the peroxyacid, and it may also accelerate the corrosion rate of equipment. In some embodiments, the degradation auxiliary agent includes copper chloride, cuprous chloride, zinc chloride, potassium permanganate, sulfuric acid, phosphoric acid, or a combination thereof.

In some embodiments, the degradation solution further includes 5 to 34 parts by weight of water. The additionally added water can be used to adjust the concentrations of the composition in the degradation solution to prevent the reaction from being overly violent. If the amount of the additionally added water is too high, the effect of the degradation solution may be lowered.

One embodiment of the disclosure provides a method of decomposing epoxy resin, including: soaking a waste material containing epoxy resin in the described degradation solution at a temperature of 25° C. to 100° C. under a normal pressure for 1 to 72 hours, wherein the epoxy resin in the waste material is decomposed by the degradation solution to form a residual liquid. If the soaking time is too short, the degradation effect will be insufficient. If the soaking time is too long, the degradation effect cannot be further enhanced but the cost due to longer treatment time will increase.

The degradation solution is mainly aimed at decomposing epoxy resin. If the resin in the waste materials is another resin such as polyurethane, the polyurethane will not be efficiently decomposed by the degradation solution. If the temperature of the degradation solution is too low, the effect of degrading the epoxy resin will be too low. If the temperature of the decomposition solution is too high, a large amount of the degradation solution will be volatilized, and it will be difficult to recycle and reuse the C₂ to C₄ organic acid.

In some embodiments, the waste material may further include fiber, and the epoxy resin is decomposed by the degradation solution to separate the fiber from the waste material. In some embodiments, the method of decomposing the epoxy resin further includes washing and drying the fiber separated from the waste material in order to recycle and reuse the fiber. In general, the performance (tensile strength and elastic modulus) of the recycled fiber was at least 95% of the performance of the original fiber. In some embodiments, the fiber includes carbon fiber, glass fiber, or a combination thereof.

In some embodiments, the method of decomposing the epoxy resin further including distilling the residual liquid or concentrating the residual liquid under reduced pressure to recycle the C₂ to C₄ organic acid. Since the C₂ to C₄ organic acid can be recycled and reused, it may further decrease the cost of decomposing the epoxy resin.

Below, exemplary embodiments will be described in detail so as to be easily realized by a person having ordinary knowledge in the art. The inventive concept may be embodied in various forms without being limited to the exemplary embodiments set forth herein.

### EXAMPLES

### Preparation Example 1

100 g of epoxy resin DEN-438 (commercially available from Dow), 87 g of epoxy resin EPON-1001 (commercially available from Shell), and curing agent DICY (commercially available from Nippon Carbide Industries Co., Inc., Japan) were mixed. 0.64 g of the mixture was then coated on 1.19 g of carbon fiber (commercially available from Hyosung, Korea) and heated to 120° C. to be cured for 1 hour to obtain an epoxy resin composite material A.

### Preparation Example 2

80 g of epoxy resin MY-720 (commercially available from Ciba-Geigy, Switzerland) and curing agent DDS (commercially available from Ciba-Geigy, Switzerland) were mixed and then heated to 180° C. to be cured for 2 hours to obtain an epoxy resin bulk material B.

### Preparation Example 3

295 g of hydrogen peroxide aqueous solution (50 vol %), 100 g of water, 266 g of citric acid, 233 g of acetic anhydride, and 33 g of phosphoric acid were mixed to form a degradation solution I.

### Preparation Example 4

236 g of hydrogen peroxide aqueous solution (50 vol %) and 832 g of acetic anhydride were mixed to form a degradation solution II.

### Example 1

50*70*0.3 cm³ of waste wind blade scrap of glass fiber composite (containing 35 wt % of epoxy resin) was soaked in the degradation solution I at room temperature and kept for 70 hours, thereby removing 38% of the epoxy resin (swelling and delamination).

### Comparative Example 1

5*5*0.3 cm³ of the waste wind blade scrap of glass fiber composite (containing 35 wt % of epoxy resin) was soaked in the degradation solution II at room temperature and kept for 70 hours, the result showed that the solution failed to remove the epoxy resin (only swelling).

### Example 2

20*10*2 cm³ of the waste wind blade scrap of glass fiber composite (containing 35 wt % of epoxy resin) was soaked in the degradation solution I at 80° C. and kept for 1 hour, thereby removing 99% of the epoxy resin. The obtained glass fibers were taken from the residual liquid, then washed and dried. The performance (tensile strength and elastic modulus measured according to the standard ASTM D3379) of the recycled glass fibers was 95% of the performance of the original glass fibers.

### Comparative Example 2

20*10*2 cm³ of the waste wind blade scrap of glass fiber composite (containing 35 wt % of epoxy resin) was soaked in the degradation solution II at 80° C. and kept for 2 hours, thereby removing 96% of the epoxy resin. The glass fibers were taken from the residual liquid, then washed and dried. The performance (tensile strength and elastic modulus measured according to the standard ASTM D3379) of the recycled glass fibers was 84% of the performance of the original glass fibers.

### Comparative Example 3

20*10*0.2 cm³ of the carbon fiber reinforced composite wastes from car modification parts (containing 50 wt % of epoxy resin) was soaked in the degradation solution I at 5° C. and kept for 72 hours, the result showed that the solution failed to remove the resin (only swelling and delamination).

### Example 3

20*10*0.2 cm³ of the carbon fiber reinforced composite wastes from car modification parts (containing 50 wt % of epoxy resin) was soaked in the degradation solution I at 25° C. and kept for 70 hours, thereby removing 25% of the epoxy resin.

### Example 4

20*10*0.2 cm³ of the carbon fiber reinforced composite wastes from car modification parts (containing 50 wt % of epoxy resin) was soaked in the degradation solution I at 80° C. and kept for 2 hours, thereby removing 99% of the epoxy resin. The carbon fibers were taken from the residual liquid, then washed and dried. The performance (tensile strength and elastic modulus measured according to the standard ASTM D3379) of the recycled carbon fibers was 97% of the performance of the original carbon fibers.

### Comparative Example 4

20*10*0.2 cm³ of the carbon fiber reinforced composite wastes from car modification parts (containing 50 wt % of epoxy resin) was soaked in the degradation solution I at 120° C. and kept for 1 hour, thereby removing 99% of the epoxy resin. The carbon fibers were taken from the residual liquid, then washed and dried. The performance (tensile strength and elastic modulus measured according to the standard ASTM D3379) of the recycled carbon fibers was 97% of the performance of the original carbon fibers. A large amount of the degradation solution was volatilized and could not be recycled to reuse (e.g. recycling the acetic acid).

### Comparative Example 5

2*5*1 cm³ of the waste wind blade scrap of glass fiber composite (containing 35 wt % of epoxy resin) was soaked in the degradation solution I at 5° C. and kept for 72 hours, the result showed that the solution failed to remove the epoxy resin (only swelling).

### Example 5

20*10*2 cm³ of the waste wind blade scrap of glass fiber composite (containing 35 wt % of epoxy resin) was soaked in the degradation solution I at 25° C. and kept for 70 hours, thereby removing 25% of the epoxy resin (delamination).

### Example 6

20*10*2 cm³ of the waste wind blade scrap of glass fiber composite (containing 35 wt % of epoxy resin) was soaked in the degradation solution I at 80° C. and kept for 1 hour, thereby removing 99% of the epoxy resin. The glass fibers were taken from the residual liquid, then washed and dried. The performance (tensile strength and elastic modulus measured according to the standard ASTM D3379) of the recycled glass fibers was 95% of the performance of the original glass fibers.

### Comparative Example 6

20*10*2 cm³ of the waste wind blade scrap of glass fiber composite (containing 35 wt % of epoxy resin) was soaked in the degradation solution I at 120° C. and kept for less than 1 hour, thereby removing 92% of the epoxy resin. The glass fibers were taken from the residual liquid, then washed and dried. The performance (tensile strength and elastic modulus measured according to the standard ASTM D3379) of the recycled glass fibers was 82% of the performance of the original glass fibers. A large amount of the degradation solution was volatilized and could not be recycled to reuse (e.g. recycling the acetic acid), and the performance of the recycled glass fibers were lowered.

### Example 7

The epoxy resin composite material A was soaked in the degradation solution I at 92° C. and kept for 1 hour, thereby completely removing the epoxy resin.

### Comparative Example 7

The epoxy resin composite material A was soaked in the degradation solution II at 108° C. and kept for 1 hour, thereby only partially removing the epoxy resin.

### Example 8

The epoxy resin bulk material B was soaked in the degradation solution I at 92° C. and kept for 3 hours, such that the weight of the epoxy resin bulk material B was decreased by 0.87 g.

### Comparative Example 8

The epoxy resin bulk material B was soaked in the degradation solution II at 108° C. and kept for 3 hours, such that the weight of the epoxy resin bulk material B was decreased by 0.4 g.

### Preparation Example 5

100 g of hydrogen peroxide aqueous solution (50 vol %), 50 g of water, 14.3 g of oxalic acid, 23 g of acetic anhydride, and 7.5 g of phosphoric acid were mixed to form a degradation solution III.

### Comparative Example 9

The epoxy resin composite material A was soaked in the degradation solution III at 108° C. and kept for 1 hour, the result showed that the solution failed to remove the epoxy resin.

### Preparation Example 6

233 g of hydrogen peroxide aqueous solution (50 vol %), 100 g of water, 266 g of tartaric acid, 233 g of acetic anhydride, and 33 g of phosphoric acid were mixed to form a degradation solution IV.

### Comparative Example 10

The epoxy resin composite material A was soaked in the degradation solution IV at 92° C. and kept for 1 hour, the result showed that the solution only partially removed a small amount of the epoxy resin.

### Preparation Example 7

295 g of hydrogen peroxide aqueous solution (50 vol %), 100 g of water, 133 g of citric acid, 233 g of acetic anhydride, and 3.1 g of nickel nitrate were mixed to form a degradation solution V.

### Comparative Example 11

The epoxy resin composite material A was soaked in the degradation solution V at 92° C. and kept for 1 hour, it showed that the solution only partially removed a small amount of the epoxy resin.

### Preparation Example 8

295 g of hydrogen peroxide aqueous solution (50 vol %), 100 g of water, 133 g of citric acid, 233 g of acetic anhydride, and 8 g of iron (II) chloride were mixed to form a degradation solution VI.

### Comparative Example 12

The epoxy resin composite material A was soaked in the degradation solution VI at 92° C. and kept for 1 hour, the result showed that the solution failed to remove the epoxy resin.

### Comparative Example 13

A waste carbon fiber fabric prepreg (containing 41 wt % of epoxy resin) was soaked in the degradation solution II and treated by microwave (e.g. set at 700 W for 1.5 minutes and then cooled, and the above cycle was repeated 3 times). Although microwave treatment had fast heating rate, it could not continuously supply heat and its temperature was difficult to control. In addition, the degradation solution lost quickly, and the epoxy resin could not be completely decomposed. This process was also unfavorable in mass production.

### Example 9

After the degradation process, 552 g of the residual liquid of the degradation solution I was collected. The residual liquid was concentrated under a reduced pressure to obtain 458 g of an acetic acid aqueous solution.

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. A degradation solution, comprising:
100 parts by weight of 30 to 50 vol % of hydrogen peroxide aqueous solution;
44 to 80 parts by weight of C₂ to C₄ organic acid or anhydride thereof;
50 to 90 parts by weight of an organic acid containing a plurality of carboxylic acid groups; and
1 to 15 parts by weight of degradation auxiliary agent.

2. The degradation solution as claimed in claim 1, wherein the C₂ to C₄ organic acid comprises acetic acid, propionic acid, butyric acid, or a combination thereof.

3. The degradation solution as claimed in claim 1, wherein the organic acid containing a plurality of carboxylic acid groups comprises malonic acid, succinic acid, glutaric acid, maleic acid, malic acid, citric acid, or a combination thereof.

4. The degradation solution as claimed in claim 1, wherein the degradation auxiliary agent comprises copper chloride, cuprous chloride, zinc chloride, potassium permanganate, sulfuric acid, phosphoric acid, or a combination thereof.

5. The degradation solution as claimed in claim 1, further comprising 5 to 34 parts by weight of water.

6. A method of decomposing epoxy resin, comprising:
soaking a waste material containing epoxy resin in the degradation solution as claimed in claim 1 at a temperature of 25° C. to 100° C. under a normal pressure for 1 to 72 hours, wherein the epoxy resin in the waste material is decomposed by the degradation solution to form a residual liquid.

7. The method as claimed in claim 6, wherein the waste material further comprises a fiber, and the epoxy resin is decomposed by the degradation solution to separate the fiber from the waste material.

8. The method as claimed in claim 7, further comprising washing and drying the fiber separated from the waste material, and recycling and reusing the fiber.

9. The method as claimed in claim 7, wherein the fiber comprises carbon fiber, glass fiber, or a combination thereof.

10. The method as claimed in claim 6, further comprising distilling the residual liquid or concentrating the residual liquid under reduced pressure to recycle the C₂ to C₄ organic acid.
